(19) United States
(12) Patent Application Publication
(10) Pub. No.: US 2020/0178340 A1
(43) Pub. Date: Jun. 4, 2020

(54) Radio Link Monitoring and Failure Handling with Multiple Downlink (DL) Control Channels

(71) Applicant: MediaTek Singapore Pte. Ltd., Singapore (SG)

(72) Inventors: Yuanyuan Zhang, Beijing (CN); Per Johan Mikael Johansson, Kungsangen (SE); Chia-Hao Yu, Hsin-Chu (TW)

(21) Appl. No.: 16/784,420

(22) Filed: Feb. 7, 2020

Related U.S. Application Data
(63) Continuation of application No. PCT/CN2018/099886, filed on Aug. 10, 2018.

(30) Foreign Application Priority Data
Aug. 10, 2017 (CN) PCT/CN2017/096770

(51) Int. Cl. H04W 76/19; H04W 24/08; H04W 72/04

(52) U.S. Cl. CPC H04W 76/19; H04W 72/042; H04W 24/08

(57) ABSTRACT

Apparatus and methods are provided for RLM and RLF procedure in a wireless network. In one novel aspect, the UE generates radio link monitoring (RLM) measurement results for multiple physical downlink control channels (PDCCHs), groups the PDCCHs to multiple RLM groups based on a grouping rule to generate link status for each RLM group based on a RLM group status rule, wherein each RLM group contains one or more PDCCHs and belongs to a critical type or a non-critical type based on the one or more PDCCH types in the group and initiates a radio resource control (RRC) connection re-establishment procedure if the link status of a critical type of RLM group indicates link failure, otherwise, generates a radio link failure (RLF) report to the wireless network if the link status of a non-critical type of RLM group indicates link failure.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2018/099886, with an international filing date of Aug. 10, 2018, which in turn claims priority from International Application No. PCT/CN2017/096770 entitled “APPARATUS AND METHODS FOR RADIO LINK MONITORING AND FAILURE HANDLING WITH MULTIPLE DL CONTROL CHANNELS IN NR”, filed on Aug. 10, 2017. This application is a continuation of International Application No. PCT/CN2018/099886, which claims priority from International Application No. PCT/CN2017/096770. International Application No. PCT/CN2018/099886 is pending as of the filing date of this application, and the United States is a designated state in International Application No. PCT/CN2018/099886. The disclosure of each of the foregoing documents is incorporated herein by reference.

### TECHNICAL FIELD

The disclosed embodiments relate generally to wireless communication, and, more particularly, to radio link monitoring and failure handling.

### BACKGROUND

The fifth generation (5G) radio access technology (RAT) will be a key component of the modern access network. It will address high traffic growth and increasing demand for high-bandwidth connectivity. It will also support massive numbers of connected devices and meet the real-time, high-reliability communication needs of mission-critical applications. Both the standalone new radio (NR) deployment and non-standalone NR with LTE/eLTE deployment will be considered. For example, the incredible growing demand for cellular data inspired the interest in high frequency (HF) communication system. One of the objectives is to support frequency ranges up to 100 GHz. The available spectrum of HF band is 200 times greater than conventional cellular system. The very small wavelengths of HF enable large number of miniaturized antennas to be placed in small area. The miniaturized antenna system can form very high gain, electrically steerable arrays and generate high directional transmissions through beamforming.

Beamforming is a key enabling technology to compensate the propagation loss through high antenna gain. The reliance on high directional transmissions and its vulnerability to the propagation environment will introduce particular challenges including intermittent connectivity and rapidly adaptable communication. HF communication will depend extensively on adaptive beamforming at a scale that far exceeds current cellular system. High reliance on directional transmission such as for synchronization and signals broadcasting may delay the base station (BS) detection during cell search for an initial connection setup and handover, since both the base station and the mobile stations (MSs) need to scan over a range of angles before a base station can be detected. HF signals are extremely susceptible to shadowing due to the appearance of obstacles such as human body and outdoor materials. Therefore, signal outage due to shadowing is a larger bottleneck in delivering uniform capacity. For HF-NR with beam operation, multiple beams cover the cell. UE needs to consider the multiple beams from the network side for downlink quality detection. UE needs to utilize the collective measurement results of different beams to represent the radio link quality of the serving cell.

The DL radio link monitor (RLM) and link status determination, such as radio link failure (RLF) procedure in the current cellular system does not consider the multi-beam, highly directional HF network. Under current RLM and RLF procedure, it is inefficient to handle the multi-beam NR network.

Improvements and enhancements are required for RLM and RLF procedures for the NR network.

### SUMMARY

Apparatus and methods are provided for RLM and RLF procedure in a wirelessnetwork. In one novel aspect, the UE generates radio link monitoring (RLM) measurement results for multiple physical downlink control channels (PDCCHs), groups the PDCCHs to multiple RLM groups based on a grouping rule to generate link status for each RLM group based on a RLM group status rule, wherein each RLM group contains one or more PDCCHs and belongs to a critical type or a non-critical type based on the one or more NR-PDCCH types in the group and initiates a radio resource control (RRC) connection re-establishment procedure if the link status of a critical type of RLM group indicates link failure, otherwise, generates a radio link failure (RLF) report to the wireless network if the link status of a non-critical type of RLM group indicates link failure. In one embodiment, the grouping rule is one selecting from a grouping set comprising: grouping PDCCHs supporting same functions in one group, grouping PDCCHs with a same numerology in one group, and grouping PDCCHs with same radio characteristics in one group. In another embodiment, the critical type of RLM group contains at least one anchor NR-PDCCH or at least one dedicated PDCCH. In one embodiment, the link status of each RLM group is generated by consolidating measurement results for each PDCCH based on corresponding RS in the corresponding RLM group and generating Qin/Qout indication to RRC. The consolidating involves applying one consolidation rule selecting from a group comprising: selecting a best measurement result of all the measurement results for each NR-PDCCH in the corresponding RLM group; or obtaining a linear average of all measurement results in the corresponding RLM group. In one embodiment, the UE indicates that the RLF failure occurs on a common NR-PDCCH. The UE receives an RLF response. In one embodiment, the RLF response is sent on the dedicated RRC signaling. In one embodiment, the RLF response from the NR network includes system information. In another embodiment, the RLF response from the wireless network includes a command sending the UE to an IDLE mode. In yet another embodiment, the RLF sending to the wireless network further indicates at least one of the one or more RLF NR-PDCCHs and the one or more RLF NR-PDCCH RLM groups.

In another novel aspect, the UE generates RLM measurement results for each NR-PDCCH, groups the PDCCHs to multiple RLM groups and generates an RLM group link status. The UE generates an RLF indication based on the link status of the one or more RLM groups. In one embodiment, the link status of each RLM group is generated by consolidating PHY measurement results for each PDCCH based on corresponding RS in the corresponding RLM group and generating Qin/Qout indication to RRC. In one embodiment, the Qout indication is generated when all the NR-PDCCHs in the RLM group having the measurement result worse than a Qout threshold. In another embodiment, the Qin indication is generated when at least one NR-PDCCH in the RLM group having the measurement result better than a Qin threshold.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary NR wireless network with enhanced RLM and RLF for the NR network in accordance with embodiments of the current invention.

FIG. 2 illustrates an exemplary NR wireless system with multiple control beams and dedicated beams in multiple directionally configured cells in accordance with embodiments of the current invention.

FIG. 3 illustrates an exemplary control beam configuration for UL and DL of the UE in accordance with embodiments of the current invention.

FIG. 4 shows an exemplary diagram of performing RLM and declaring RLF on one NR-PDCCH in accordance with embodiments of the current invention.

FIG. 5 shows an exemplary diagram of performing RLM and declaring RLF on a group of NR-PDCCHs in accordance with embodiments of the current invention.

FIG. 6 shows an exemplary flowchart of handling RLF on one or one group of NR-PDCCHs in accordance with embodiments of the current invention.

FIG. 7 illustrates an exemplary flow chart of the UE performing the RLM and RLF procedure with RLM group in accordance with embodiment of the current invention.

FIG. 8 illustrates an exemplary flow chart of the UE performing an RLM for an RLM group in accordance with embodiments of the current invention.

### DETAILED DESCRIPTION

Reference will now be made in detail to some embodiments of the invention, examples of which are illustrated in the accompanying drawings.

In LTE, downlink (DL) radio link quality is measured by UE based on the cell-specific reference signal, which is actually mapped to a hypothetical PDCCH block error rate (BLER). It is compared with different thresholds Qout and Qin, which are corresponding to 10% BLER and 2% BLER of a hypothetical PDCCH transmission respectively. So that Qout and Qin are indicated to the RRC layer of the UE, which are used for RLF detection procedure. Upon receiving consecutive numbers of Qout, a timer T310 is started. The timer is used to supervise whether the radio link can be recovered with consecutive numbers of Qin. RLF is declared when the timer expires such that the downlink radio link quality problem of the serving cell can be detected through radio link monitoring (RLM) procedure. In LTE, the channel characteristics for the common PDCCH and the dedicated PDCCH are similar, so the common PDCCH and the dedicated PDCCH are considered as one radio link, even different formats of DCIs are received. However, in NR, it's possible that the common NR-PDCCH and the dedicated NR-PDCCH have different beam characteristics or even different numerologies on different parts of a frequency band.

The NR network also supports scalable numerologies for various use cases including enhanced mobile broadband (eMBB), massive machine type communication (mMTC) and ultra-reliable low latency communication (URLLC). Multiple OFDM numerologies can be applied to the same carrier frequency or different carrier frequencies. In order to support different numerologies on the same frequency for NR system, different types of UEs according to such different use cases will be accommodated simultaneously in a given frequency band. So scalable numerologies corresponding to scalable subcarrier spacing values would need to be supported. For each UE, multiple NR-PDCCHs corresponding to different numerologies are monitored by the UE.

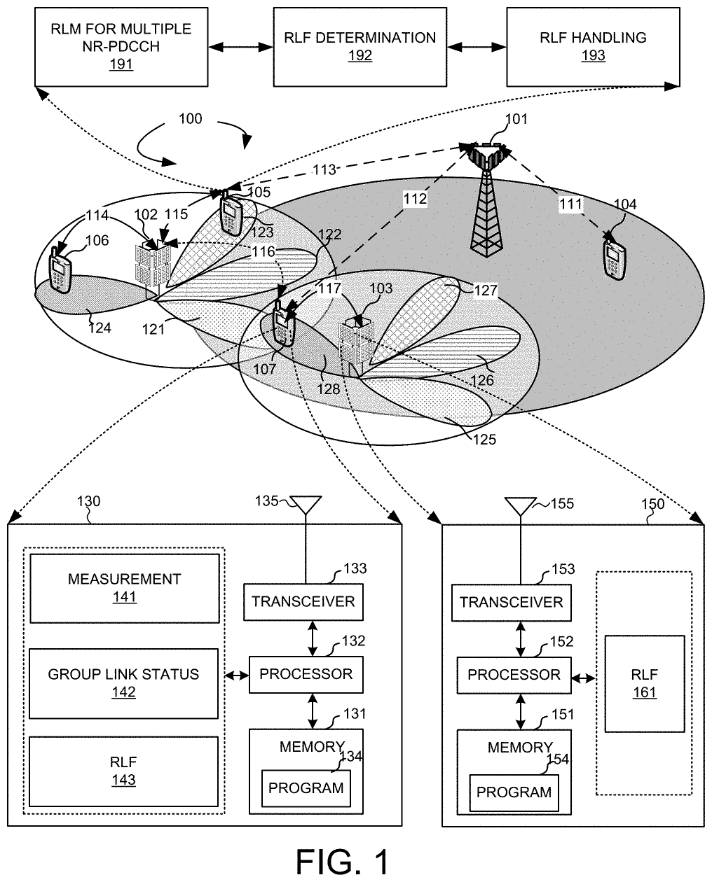

FIG. 1 is a schematic system diagram illustrating an exemplary NR wireless network 100 with enhanced RLM and RLF for the NR network in accordance with embodiments of the current invention. Wireless system 100 includes one or more fixed base infrastructure units forming a network distributed over a geographical region. The base unit may also be referred to as an access point, an access terminal, a base station, a Node-B, an eNode-B, a gNB, or by other terminology used in the art. As an example, base stations 101, 102 and 103 serve a number of mobile stations 104, 105, 106 and 107 within a serving area, for example, a cell, or within a cell sector. In some systems, one or more base stations are coupled to a controller forming an access network that is coupled to one or more core networks. eNB/gNB 101 is a conventional base station served as a macro gNB. gNB 102 and gNB 103 are HF base stations, the serving area of which may overlap with serving area of eNB/gNB 101, as well as may overlap with each other at the edge. HF gNB 102 and HF gNB 103 has multiple sectors each with multiple beams to cover a directional area respectively. Beams 121, 122, 123 and 124 are exemplary beams of gNB 102. Beams 125, 126, 127 and 128 are exemplary beams of gNB 103. The coverage of HF gNB 102 and 103 can be scalable based on the number of TRPs radiating the different beams. As an example, UE or mobile station 104 is only in the service area of gNB 101 and connected with eNB/gNB 101 via a link 111. UE 106 is connected with HF network only, which is covered by beam 124 of gNB 102 and is connected with gNB 102 via a link 114. UE 105 is in the overlapping service area of gNB 101 and gNB 102. In one embodiment, UE 105 is configured with dual connectivity and can be connected with eNB/gNB 101 via a link 113 and gNB 102 via a link 115 simultaneously. UE 107 is in the service areas of eNB/gNB 101, gNB 102, and gNB 103. In an embodiment, UE 107 is configured with dual connectivity and can be connected with eNB/gNB 101 with a link 112 and gNB 103 with a link 117. In an embodiment, UE 107 can switch to a link 116 connecting to gNB 102 upon connection failure with gNB 103.

FIG. 1 further illustrates simplified block diagrams 130 and 150 for UE 107 and gNB 103, respectively. Mobile station 107 has an antenna 135, which transmits and receives radio signals. A RF transceiver module 133, coupled with the antenna, receives RF signals from antenna 135, converts them to baseband signal, and sends them to processor 132. RF transceiver module 133 is an example, and in one embodiment, the RF transceiver module comprises two RF modules (not shown), first RF module is used for HF (high frequency) transmitting and receiving, and another RF module is used for different frequency bands transmitting and receiving which is different from the HF (high frequency). RF transceiver 133 also converts received baseband signals from processor 132, converts them to RF signals, and sends out to antenna 135. Processor 132 processes the received baseband signals and invokes different functional modules to perform features in mobile station 107. Memory 131 stores program instructions and data 134 to control the operations of mobile station 107.

Mobile station 107 also includes multiple function modules that carry out different tasks in accordance with embodiments of the current invention. A measurement module/circuit 141 generates radio link monitoring (RLM) measurement results at a physical (PHY) layer for each physical downlink control channel (PDCCH) in the NR network. A group link status module/circuit 142 groups the NR-PDCCHs to multiple RLM groups based on a grouping rule to generate link status for each RLM group based on an RLM group status rule, wherein each RLM group contains one or more NR-PDCCHs and belongs to a critical type or a non-critical type based on the one or more NR-PDCCH types in the group. A radio link failure (RLF) module/circuit 143 initiates a radio resource control (RRC) connection re-establishment procedure if the link status of a critical type of RLM group indicates link failure, otherwise, generates a RLF indication and sends RLF report to the NR network if the link status of a non-critical type of RLM group indicates link failure.

Similarly, gNB 103 has an antenna 155, which transmits and receives radio signals. A RF transceiver module 153, coupled with the antenna, receives RF signals from antenna 155, converts them to baseband signals, and sends them to processor 152. RF transceiver 153 also converts received baseband signals from processor 152, converts them to RF signals, and sends out to antenna 155. Processor 152 processes the received baseband signals and invokes different functional modules to perform features in gNB 103. Memory 151 stores program instructions and data 154 to control the operations of gNB 103. gNB 103 also includes multiple function modules that carry out different tasks in accordance with embodiments of the current invention. A RLF circuit 161 handles RLM and RLF procedures of the gNB 103.

FIG. 1 further shows different protocol layers and the interaction between different layers that handle RLM and RLF in the NR system with multiple beam operation. UE 105 has an RLM procedure 191 corresponding to one or more NR-PDCCH RLM groups on the serving cell, an RLF determination procedure 192, and an RLF handling procedure 193, which determines whether to send a RLF indication to gNB or initiate RRC connection re-establishment procedure.

RLM procedure 191 performs RLM on one or multiple NR-PDCCHs through a RLM monitor. For each NR-PDCCH, the RLM monitor measures different reference signals, which are mapped to a hypothetical NR-PDCCH block error rate (BLER). It is compared to the thresholds Qout and Qin, which are corresponding to x % BLER, such as 10%, and Y % BLER, such as 2% of a hypothetical NR-PDCCH transmission, respectively. X is larger than Y. In another embodiment, multiple NR-PDCCHs are configured into different groups. The same group of NR-PDCCHs support the same function transmitting common control signaling or dedicated control signaling, or have similar characteristics, such as, having the same beamwidth or having the same numerology. In one embodiment, one group of NR-PDCCH is anchor NR-PDCCH, responsible for particular functions, such as RRC connection maintenance. The other groups of NR-PDCCHs is non-anchor NR-PDCCH. The anchor NR-PDCCH group is a critical type of RLM group. The non-anchor NR-PDCCH group is a non-critical type of RLM group. In one embodiment, one group of NR-PDCCH is dedicated NR-PDCCH, responsible for dedicated control signaling. The other group of NR-PDCCH is common NR-PDCCH, responsible for common control signaling. The dedicated NR-PDCCH group is a critical type of RLM group. The common NR-PDCCH group is a non-critical type of RLM group. Each Qin/Qout signal is generated by consolidating multiple measurement results corresponding to different NR-PDCCHs in the same group. The NR-PDCCH group can have one or more multiple NR-PDCCHs.

The consolidation methods to generate each Qin/Qout can be one of the following: 1) The best measurement result among the group of NR-PDCCHs is used; 2) The linear average measurement result among the group of NR-PDCCHs is used. The Qout and Qin are indicated to the RRC layer of the UE, which is used for RLF determination.

RLF determination procedure 192 determines whether RLF occurs for one NR-PDCCH or one group of NR-PDCCHs. Upon receiving consecutive numbers of Qout, a timer T1 is started. The timer is used to supervise whether the radio link can be recovered with consecutive numbers of Qin. RLF is determined when the timer expires. An RLF handler 193 determines whether to send an RLF indication to network or to initiate RRC connection re-establishment procedure based on which or which RLM group of NR-PDCCH endures RLF. In one embodiment, RRC connection re-establishment is initiated upon RLF detection on any group of NR-PDCCHs. In another embodiment, the RRC connection re-establishment is only initiate if the RLM group is a critical type of RLM group containing at least one anchor PDCCH or one dedicated PDCCH. In yet another embodiment, the RLF indication is sent to the network if the RLM group is a non-critical type of RLM group containing only non-anchor and/or common PDCCH.

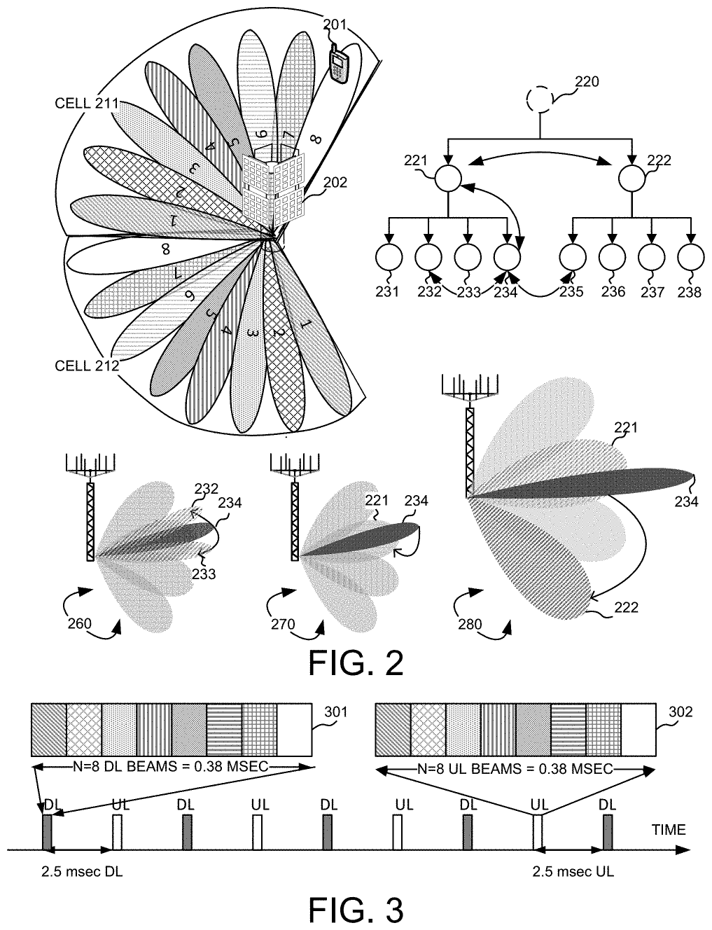

FIG. 2 illustrates an exemplary NR/HF wireless system with multiple control beams and dedicated beams in multiple directionally configured cells. A UE 201 is connected with a gNB 202. gNB 202 is directionally configured with multiple sectors/cells. Each sector/cell is covered by a set of coarse TX control beams. As an example, cells 221 and 222 are configured cells for gNB 202. In one example, three sectors/cells are configured, each covering a 120° sector. In one embodiment, each cell is covered by eight control beams. Different control beams are time division multiplexed (TDM) and distinguishable. Phased array antenna is used to provide a moderate beamforming gain. The set of control beams is transmitted repeatedly and periodically. Each control beam broadcasts the cell-specific information such as synchronization signal, system information, and beam-specific information. Besides coarse TX control beams, there are multiple dedicated beams, which are finer-resolution BS beams.

Beam tracking is an important function for the NR mobile stations. Multiple beams, including coarse control beams and dedicated beams are configured for each of the directionally configured cells. The UE monitors the qualities of its neighboring beams by beam tracking. FIG. 2 illustrates exemplary beam tracking/switching scenarios. A cell 220 has two control beams 221 and 222. Dedicated beams 231, 232, 233 and 234 are associated with control beam 221. Dedicated beams 235, 236, 237 and 238 are associated with control beam 222. In one embodiment, the UE connected via beam 234, monitors its neighboring beams for control beam 234. Upon a beam-switching decision, the UE can switch from beam 234 to beam 232 and vice versa. In another embodiment, the UE can fall back to control beam 221 from dedicated beam 234. In yet another embodiment, the UE also monitors dedicated beam 235 configured for control beam 222. The UE can switch to dedicated beam 235, which belongs to another control beam.

FIG. 2 also illustrates three exemplary beam-switching scenarios 260, 270 and 280. UE 201 monitors neighboring beams. The sweeping frequency depends on the UE mobility. The UE detects dropping quality of the current beam when the current beam quality degrades by comparing with coarse resolution beam quality. The degradation may be caused by tracking failure, or the channel provided by refined beam is merely comparable to the multipath-richer channel provided by the coarse beam. Scenario 260 illustrates the UE connected with dedicated beam 234 monitors its neighboring dedicated beams 232 and 233 configured for its control beam, i.e. control beam 221. The UE can switch to beam 232 or 233. Scenario 270 illustrates the UE connected with 234 can fall back to the control beam 221. Scenario 280 illustrates the UE connected with 234 associated with control beam 221 can switch to another control beam 222.

FIG. 3 illustrates an exemplary control beam configuration for UL and DL of the UE in accordance with the current invention. A control beam is a combination of downlink and uplink resources. The linking between the beam of the DL resource and the beam of the UL resources is indicated explicitly in the system information or beam-specific information. It can also be derived implicitly based on some rules, such as the interval between DL and UL transmission opportunities. In one embodiment, A DL frame 301 has eight DL beams occupying a total of 0.38 msec. A UL frame 302 has eight UL beams occupying a total of 0.38 msec. The interval between the UL frame and the DL frame is 2.5 msec.

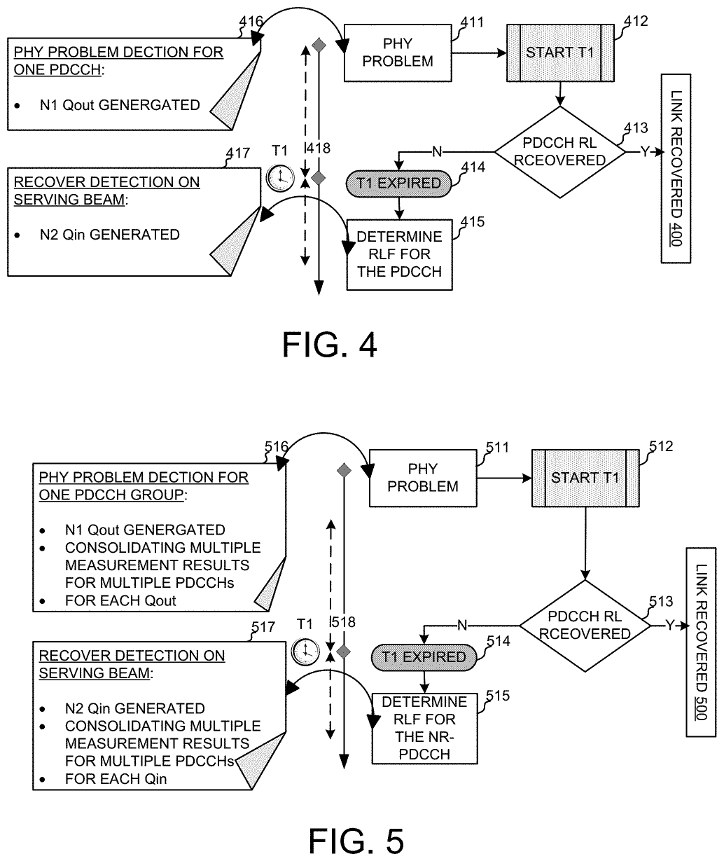

FIG. 4 shows an exemplary diagram of performing RLM and declaring RLF on one NR-PDCCH in accordance with embodiments of the current invention. At step 411, one PHY layer problem condition is detected on the NR-PDCCH. In one embodiment, a predefined problem condition in 416 is a number (N1) of Qout is generated based on the measurement on the corresponding reference signal. At step 412, upon the PHY layer problem is detected, the UE starts T1 timer. At step 413, the UE determines if radio quality of the NR-PDCCH is recovered within a time period of the T1 timer. If Yes, the UE moves to a step 400 in which the radio link is recovered; Otherwise, when the T1 timer 418 expires in step 414, the UE determines RLF for the NR-PDCCH in step 415 and declares RLF. In one embodiment, at step 413, whether the NR-PDCCH is to be recovered is determined according to the recovery conditions 417. A recovery condition in 417 is based on another number of Qin generated based on the measurement on the reference signal for the NR-PDCCH.

FIG. 5 shows an exemplary diagram of performing RLM and declaring RLF on an RLM group of NR-PDCCHs in accordance with embodiments of the current invention. At step 511, one PHY layer problem condition is detected for the RLM group of NR-PDCCHs. In one embodiment, a predefined problem condition in 516 is a number (N1) of Qout is generated based on the measurement on the corresponding reference signals for the RLM group of NR-PDCCHs. At step 512, upon detecting the PHY layer problem, the UE starts T1 timer. If at step 513, the UE determines if the radio quality of the NR-PDCCH is recovered within a time period of the T1 timer. If Yes, the UE moves to a step 500 where the radio link is recovered. Otherwise, when the T1 timer 518 expires in step 514, the UE determines an RLF for the RLM group of the NR-PDCCHs in step 515 and declares RLF. In one embodiment, at step 513, whether the RLM group of NR-PDCCHs are to be recovered is determined according to the recovery conditions 517. A recovery condition in 517 is based on another number of Qin generated based on the measurement on the reference signals for the group of NR-PDCCHs.

In one novel aspect, the NR-PDCCHs are grouped into multiple RLM groups. The PHY monitors each NR-PDCCH. When the measurement of a NR-PDCCH is worse than a Qout threshold, the NR-PDCCH is considered with a link status failure. In one embodiment, when a first number of NR-PDCCH in the RLM group has a link status failure, the Qout signal is generated for the RLM group. In one embodiment, the number of link status failure of NR-PDCCHs in the RLM group to trigger the Qout signal is all the NR-PDCCHs in the RLM group. When a second number of NR-PDCCH in the RLM group has measurement better than a predefined threshold, the link status of the RLM group is considered recovered. In one embodiment, the number of link status recover of NR-PDCCHs in the RLM group to trigger the recovered Qin signal is one NR-PDCCH.

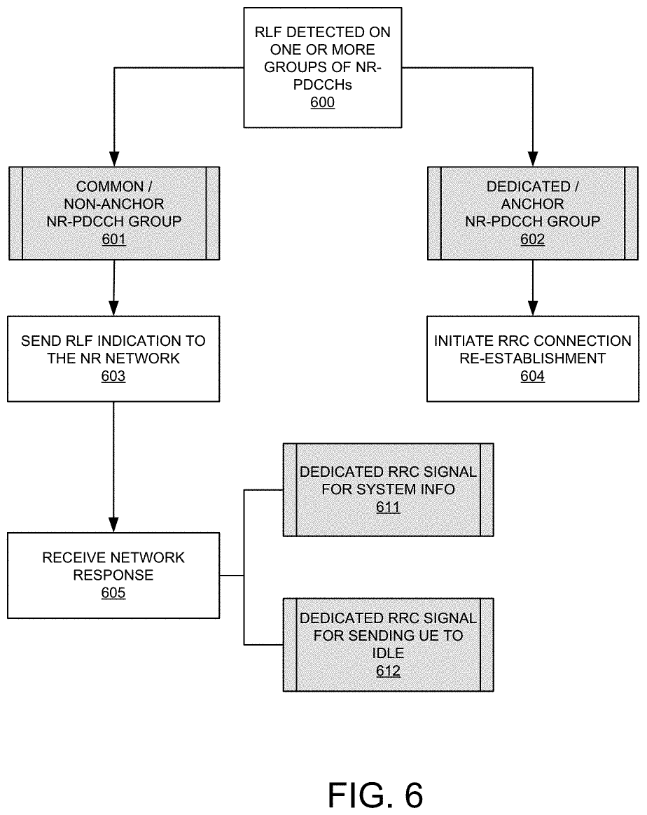

FIG. 6 shows an exemplary flowchart of handling RLF on one or one group of NR-PDCCHs in accordance with embodiments of the current invention. When RLF is detected for one or one group of NR-PDCCHs in step 600, the UE determines whether the NR-PDCCH or the group of NR-PDCCHs is a critical NR-PDCCH group. The NR-PDCCH group is a critical NR-PDCCH group if it contains at least one anchor NR-PDCCH or at least one dedicated NR-PDCCH. If RLF is detected on the critical type of RLM group with at least one anchor/dedicated NR-PDCCH in step 602, the UE starts another timer T2 and initiates RRC connection re-establishment procedure in step 604. If RLF is detected on non-critical RLM group with all non-anchor/common NR-PDCCH in step 601, the UE sends one RLF report to network informing which one or which groups of NR-PDCCHs endure RLF in step 603. When the network receives the indication, it may send an RLF response. In one embodiment, the RLF response is via the dedicated RRC signaling. At step 605, the UE receives the RLF response through the dedicated RRC signal. In one embodiment, at step 612, the RLF response sends command for the UE to go into the IDLE mode. In another embodiment, at step 611, the RLF response includes system information.

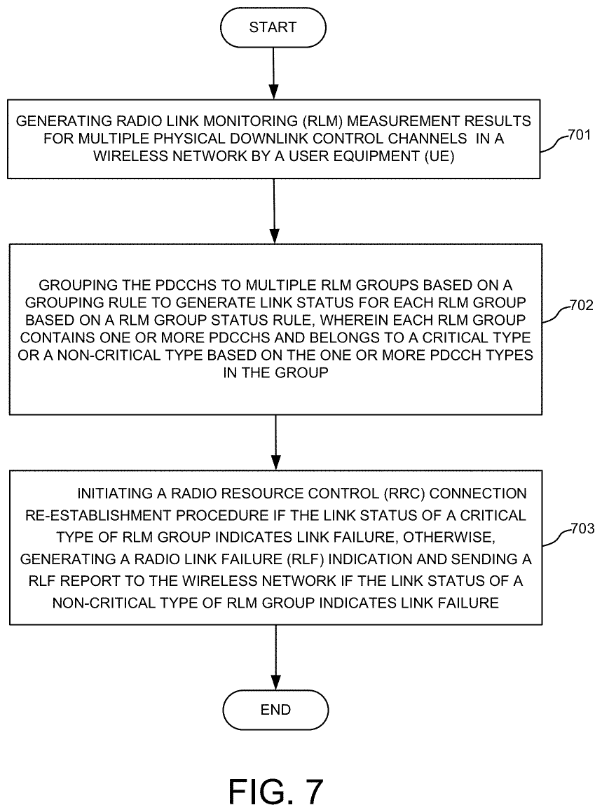

FIG. 7 illustrates an exemplary flow chart of the UE performing the RLM and RLF procedure with RLM group in accordance with embodiment of the current invention. At step 701, the UE generates RLM measurement results for multiple PDCCHs in a wireless network. At step 702, the UE groups the PDCCHs to multiple RLM groups based on a grouping rule to generate link status for each RLM group based on a RLM group status rule, wherein each RLM group contains one or more PDCCHs and belongs to a critical type or a non-critical type based on the one or more NR-PDCCH types in the group. At step 703, the UE initiates a RRC connection re-establishment procedure if the link status of a critical type of RLM group indicates link failure, otherwise, generates a RLF indication and sends RLF report to the wireless network if the link status of a non-critical type of RLM group indicates link failure.

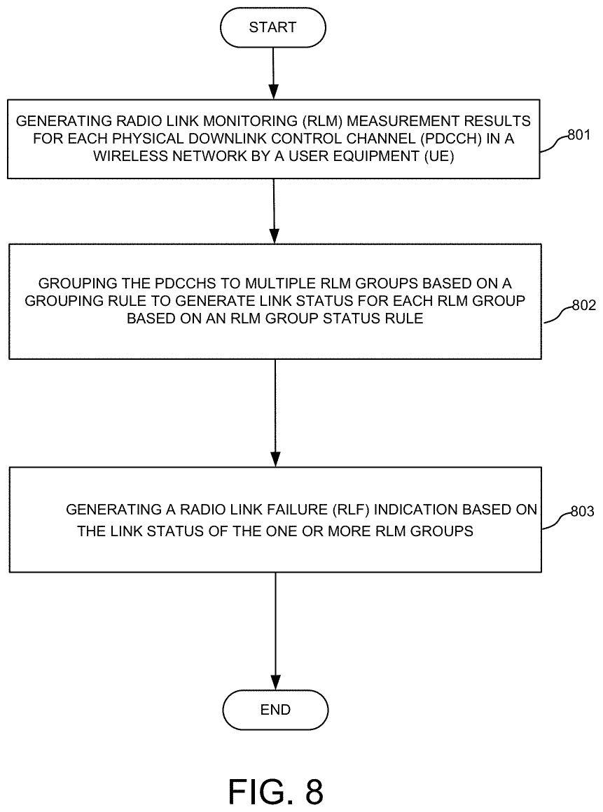

FIG. 8 illustrates an exemplary flow chart of the UE performing an RLM for an RLM group in accordance with embodiments of the current invention. At step 801, the UE generates RLM measurement results for each PDCCH in a wireless network. At step 802, the UE groups the PDCCHs to multiple RLM groups based on a grouping rule to generate link status for each RLM group based on an RLM group status rule. At step 803, the UE generates a RLF indication based on the link status of the one or more RLM groups.

Please note that the invention is not limited by NR network, it can be applied to any other suitable communication networks. Also, the embodiments in the invention can be implemented by a processor executing computer instructions storing in a non-transitory computer readable medium.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
generating radio link monitoring (RLM) measurement results for multiple physical downlink control channels (PDCCHs) in a wireless network by a user equipment (UE);
grouping the PDCCHs to multiple RLM groups based on a grouping rule to generate link status for each RLM group based on a RLM group status rule, wherein each RLM group contains one or more PDCCHs and belongs to a critical type or a non-critical type based on the one or more PDCCH types in the group; and
initiating a radio resource control (RRC) connection re-establishment procedure if the link status of a critical type of RLM group indicates link failure, otherwise,
generating a radio link failure (RLF) indication and sending a RLF report to the wireless network if the link status of a non-critical type of RLM group indicates link failure.

2. The method of claim 1, wherein the grouping rule is one selecting from a grouping set comprising: grouping PDCCHs supporting same functions in one group, grouping PDCCHs with a same numerology in one group, and grouping PDCCHs with same radio characteristics in one group.

3. The method of claim 1, wherein the critical type of RLM group contains at least one anchor PDCCH or at least one dedicated PDCCH.

4. The method of claim 1, wherein the link status of each RLM group is generated by consolidating measurement results for each PDCCH based on corresponding RS in the corresponding RLM group and generating Qin/Qout indication to RRC.

5. The method of claim 4, wherein the consolidating involves applying one consolidation rule selecting from a group comprising: selecting a best measurement result of all the measurement results for each PDCCH in the corresponding RLM group or obtaining a linear average of all measurement results in the corresponding RLM group.

6. The method of claim 4, wherein the Qout indication is generated when all the PDCCHs in the RLM group having the measurement result worse than a Qout threshold.

7. The method of claim 4, wherein the Qin indication is generated when at least one PDCCH in the RLM having the measurement result better than a Qin threshold.

8. The method of claim 1, wherein the RLF sending to the wireless network further indicates the RLF occurs for a common PDCCH.

9. The method of claim 8, further comprising receiving an RLF response from the wireless network, and wherein the RLF response is a dedicated RRC signal carrying an element selecting from a system information element and a command sending the UE to an IDLE mode.

10. The method of claim 1, wherein the RLF sending to the wireless network further indicates at least one of the one or more RLF PDCCHs and the one or more RLF PDCCH RLM groups.

11. A user equipment (UE) comprising:
a transceiver that transmits and receives radio signals in a wireless network;
a measurement circuit that generates radio link monitoring (RLM) results for multiple physical downlink control channels (PDCCHs) in the wireless network;
a group link status circuit that groups the PDCCHs to multiple RLM groups based on a grouping rule to generate link status for each RLM group based on an RLM group status rule, wherein each RLM group contains one or more PDCCHs and belongs to a critical type or a non-critical type based on the one or more PDCCH types in the group; and
a radio link failure (RLF) circuit that initiates a radio resource control (RRC) connection re-establishment procedure if the link status of a critical type of RLM group indicates link failure, otherwise, generates a RLF indication and sends a RLF report to the wireless network if the link status of a non-critical type of RLM group indicates link failure.

12. The UE of claim 11, wherein the critical type of RLM group contains at least one anchor PDCCH or at least one dedicated PDCCH.

13. The UE of claim 11, wherein the link status of each RLM group is generated by consolidating measurement results for each PDCCH based on corresponding RS in the corresponding RLM group and generating Qin/Qout indication to RRC.

14. The UE of claim 13, wherein the consolidating involves applying one consolidation rule selecting from a group comprising: selecting a best measurement result of all the measurement results for each PDCCH in the corresponding RLM group and obtaining a linear average of all measurement results in the corresponding RLM group.

15. The UE of claim 13, wherein the Qout indication is generated when all the PDCCHs in the RLM group having the measurement result worse than a Qout threshold.

16. The UE of claim 13, wherein the Qin indication is generated when at least one PDCCH in the RLM having the measurement result better than a Qin threshold

17. The UE of claim 11, wherein the RLF sending to the wireless network further indicates whether the RLF occurs for a common PDCCH.

18. The UE of claim 17, wherein the RLF circuit further receives an RLF response from the wireless network, and wherein the RLF response is a dedicated RRC signal carrying an element selecting from a system information element and a command sending the UE to an IDLE mode.

19. The UE of claim 11, wherein the RLF sending to the wireless network further indicates at least one of the one or more RLF PDCCHs and the one or more RLF PDCCH RLM groups.

20. A non-transitory computer readable medium storing computer instructions that, when executed by a processor, cause the processor to perform a method, the method comprising:
generating radio link monitoring (RLM) measurement results for multiple physical downlink control channels (PDCCHs) in a wireless network;
grouping the PDCCHs to multiple RLM groups based on a grouping rule to generate link status for each RLM group based on a RLM group status rule, wherein each RLM group contains one or more PDCCHs and belongs to a critical type or a non-critical type based on the one or more PDCCH types in the group; and
initiating a radio resource control (RRC) connection re-establishment procedure if the link status of a critical type of RLM group indicates link failure, otherwise,
generating a radio link failure (RLF) indication and sending a RLF report to the wireless network if the link status of a non-critical type of RLM group indicates link failure.
